(19) United States
(12) Patent Application Publication
(10) Pub. No.: US 2022/0000040 A1
(43) Pub. Date: Jan. 6, 2022

(54) MULTIPURPOSE ASSEMBLY RESEMBLING A POTTED PLANT

(71) Applicant: Michael Joseph Grenier, Concord, NH (US)

(72) Inventor: Michael Joseph Grenier, Concord, NH (US)

(21) Appl. No.: 17/480,898

(22) Filed: Sep. 21, 2021

Related U.S. Application Data
(60) Provisional application No. 63/085,884, filed on Sep. 30, 2020.
(60) Provisional application No. 63/085,100, filed on Sep. 29, 2020.

(51) Int. Cl. A01G 9/02

(52) U.S. Cl. CPC A01G 9/02

(57) ABSTRACT

An assembly that provides an appearance of a potted plant and can be used for multiple purposes. The assembly includes an upper section mounted to a lower section. Each the upper section and the lower section having an inner volume. The upper section can be switched between an open state and a closed state. The upper section can be switched to the open state for gaining access to the inner volume of the lower section. An upstanding artificial plant extends from the inner volume of the upper section.

### CROSS-REFERENCE TO RELATED APPLICATIONS

This application claims priority from the U.S. provisional patent application Ser. No. 63/085,884, filed on Sep. 30, 2020; this application also claims priority from the U.S. provisional patent application Ser. No. 63/085,100, filed on Sep. 29, 2020; this application also claims priority from the U.S. provisional patent application Ser. No. 63/085,884, filed on Sep. 30, 2020, all the above three applications are incorporated herein by reference in its entirety.

### FIELD OF INVENTION

The present invention is related to a multipurpose container, and more particularly, the present invention is related to a multipurpose assembly that resembles a potted artificial plant.

### BACKGROUND

There has been an ever-increasing trend to use artificial plants instead of real plants, in particular the flower plants. The artificial plants are an imitation of the real plants and are used for both residential and commercial decoration. Looks like the real plant, the artificial plant does not require laborious maintenance and may also be cheaper than real plants. The artificial plants can be placed in pots/vases to further imitate the potted real plants. The pots or vases are containers that are available in a range of sizes.

Unlike real plants, artificial plants do not require a medium, like soil for growth. The utility of vases/pots is just for decoration. Based on the size, the vase/pot may occupy different size areas in a home or office. Also, the vase/pot does not have any utility besides aesthetic purposes. Both the area occupied by the vase/pot and the cost of the vase/pot are a waste of resources.

Thus, a need is appreciated fora multipurpose assembly that resembles a potted plant for aesthetic purposes.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a multipurpose assembly that resembles a potted artificial plant for aesthetic appearance.

It is another object of the present invention that the assembly is economical to manufacture.

It is still another object of the present invention that the assembly can be used for multiple purposes.

It is yet another object of the present invention that the assembly can be used for both residential and commercial purposes.

It is a further object of the present invention that the assembly can be placed similar to a potted artificial plant.

It is still a further object of the present invention that the assembly can be produced in a range of sizes and shapes.

It is an additional object of the present invention that the container can be manufactured from a range of materials.

In one aspect, disclosed is an assembly that provides an appearance of a potted plant and can be used for multiple purposes. The assembly includes a container having an upper section and a lower section. Each the upper section and the lower section having an inner volume. The upper section can be switched between an open state and a closed state. The upper section can be switched to the open state for gaining access to the inner volume of the lower section. An upstanding artificial plant extends from the inner volume of the upper section.

In one aspect, the inner volume of the upper section is porous permitting the exchange of air between the inner volume of the lower section and the atmosphere.

In one aspect, the container or parts of the container can be made of transparent material.

In one aspect, the upstanding artificial plant is interchangeably mounted in the upper section.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is an exploded view of the assembly showing an artificial plant, an upper section, and a lower section, according to the present invention.

FIG. 2 is a perspective view of another exemplary embodiment of the assembly, according to the present invention.

FIG. 3 is an exploded view of another exemplary embodiment of the assembly, according to the present invention.

FIG. 4 is an exploded view of another exemplary embodiment of the assembly, according to the present invention.

FIG. 5 is an exploded view of another exemplary embodiment of the assembly, according to the present invention.

FIG. 6 shows the upper section and the lower section of the assembly, the upper section has a gasket, according to an exemplary embodiment of the present invention.

FIG. 7 is an exploded view of the assembly showing an artificial plant, a casing, an upper section, and a lower section, according to the present invention.

FIG. 8 is another exemplary embodiment of the assembly, according to the present invention.

FIG. 9 shows another exemplary embodiment of the assembly, according to the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

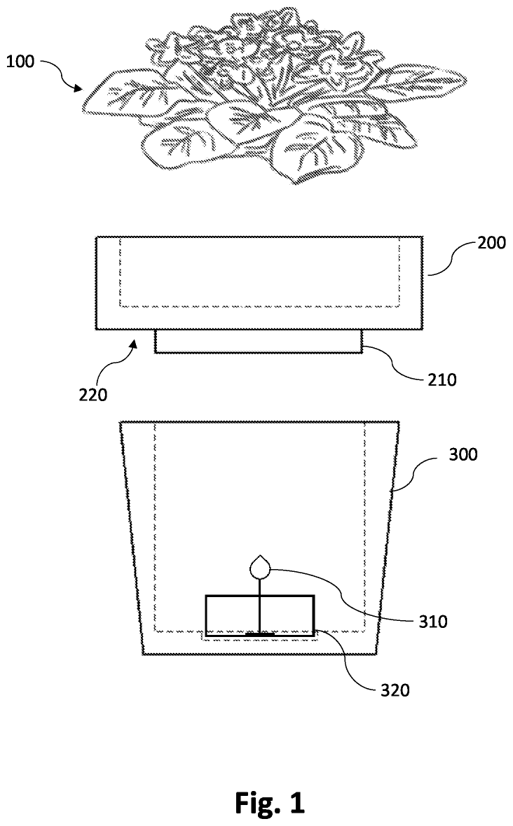

Disclosed is a multipurpose assembly that can resemble a potted plant for decoration purposes. Referring to FIG. 1 which is an exploded view of the disclosed assembly having an artificial plant 100 and an upper section 200 and a lower section 300. Each of the upper section 200 and the lower section 300 can be seen having an inner volume. The upper section can be smaller in size compared to the lower section. The upper section 200 can have a base and an upstanding wall that extends from the periphery of the base. The upper section is shown cylindrical in FIG. 1, however, different shapes of the upper section are within the scope of the present invention, such as cuboid. The base and the upstanding walls define the inner volume of the upper section. The upper section can be filled with an inert material such as foam, sand, Styrofoam, resin, plaster, rock, pebbles, stones, and like materials for aesthetic purposes and holding the artificial plant. The artificial plant 100 in an upstanding configuration can be mounted to the base of the upper section. In case, the inner volume of the upper section is having a filling of inert material, the plant can be inserted through the inert material. It is to be understood that a variety of artificial plants can be interchangeably mounted in the upper section and all such artificial plants including flower plants are within the scope of the present invention. The artificial plant can adhere to the upper surface of the base of the upper section. Alternatively, the artificial plant 100 can be inserted into the inert material contained in the inner volume of the upper section. It is to be understood that the base of the upper section can be optional, and the artificial plant can be mounted to the inert material filled in the inner volume of the upper section.

The lower surface of the base of the upper section can have a cylindrical sleeve 210 that extends downward from the center of the base. The lower surface of the base continuous with a wall of the cylindrical sleeve forms a step 220, wherein the step can juxtapose to a rim and inner wall of the lower section permitting the upper section to mount to the lower section. In one case, the cylindrical sleeve can snap-fit into the lower section. Alternatively, the cylindrical sleeve can freely or snugly fit into the lower section. Or the upper section can threadedly mount to the lower section, wherein the cylindrical sleeve and the inner wall of the lower section can have threads. Alternatively, the upper section can be wedged fit to the lower section. It is to be understood that the sleeve is shown cylindrical in FIG. 1, however, the sleeve can be of any other shape, such as square, rectangular, or polygonal, and all such shapes are within the scope of the present invention. The sleeve can be in the form of a skirt or a solid cylindrical section. In one case, a layer of rubbery material can be provided on step 220, such as to form an airtight seal between the upper section and the lower section. The layer of rubbery material may also prevent any shocks and vibrations in the upper section because of its shock-absorbing nature. Alternatively, a gasket can be provided instead of the layer of rubbery material that can be replaced. Also, in case the upper section lacks the base, the upper section can be coupled to the lower section through a hinge joint. Alternatively, the rim of the upper section and the rim of the lower section can interlock for coupling the two sections.

The lower section 300 can have a base and upstanding wall defining the inner volume of the lower section. The top of the lower section can be open but covered by the upper section 200. The lower section 300 can be used to store a range of articles, food products, and like. FIG. 1 shows an upstanding candle 310 mounted in the lower section 300. The candle 310 can have a stand that can be placed in the lower section. Alternatively, the candle can adhere to the base of the lower section 300. The base of the lower section can have a groove for receiving the candle. The candle can be placed from the top after removing the upper section. Alternatively, a window 320 can be provided in the wall of the lower section through which the candle can be placed inside the lower section. FIG. 1 shows window 320 in the wall of the lower section 300. The lower section can be made of transparent material for the light to be passthrough from the candle to illuminate the surrounding of the assembly. The base and inert filling of the upper section can have pores that allow the exchange of air between the inner volume of the lower section and the atmosphere. Moreover, the light can beam through the pores producing an aesthetic pattern. Alternatively, the air can ingress through the window in the wall of the lower section. The lower section and the upper section can be produced in different shapes and sizes, such as cube or cuboid and all such shapes and sizes are within the scope of the present invention. The dimensions of the upper section and the lower section can be such as the outer surfaces of the two sections can be continuous when the upper section is mounted on the lower section. Alternatively, the upper section can be of a larger diameter than the lower section providing a hanging appearance to the upper section.

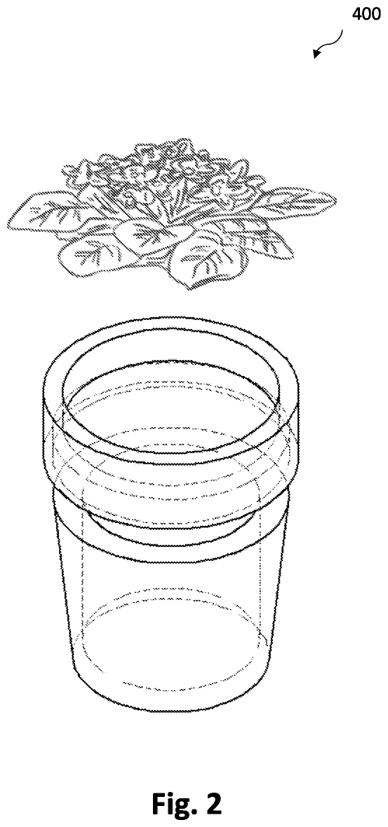

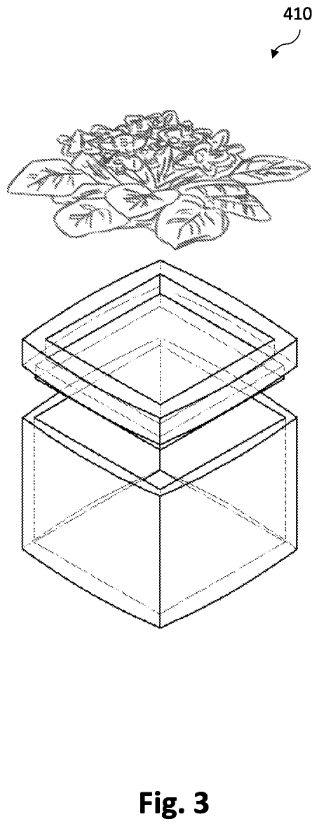

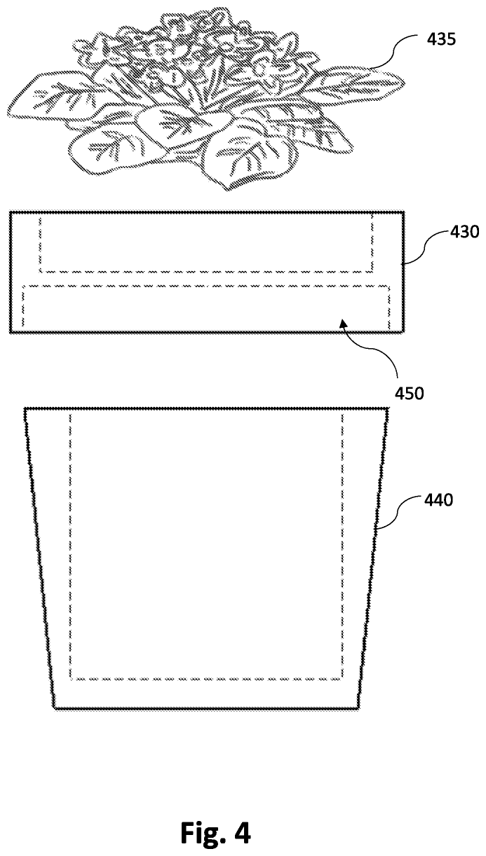

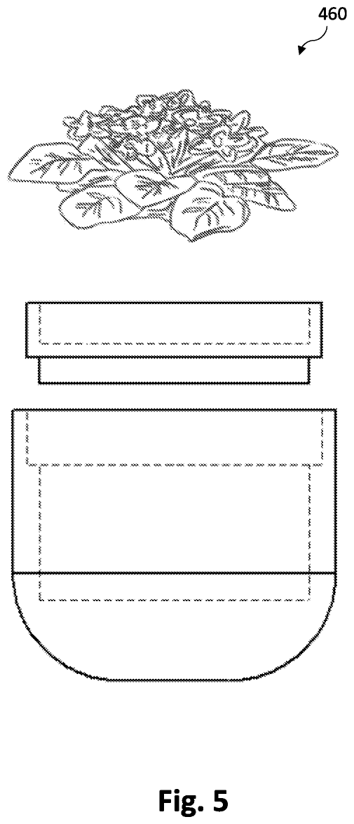

FIG. 2 is a perspective view showing an alternate embodiment of the assembly 400. FIG. 3 is a perspective view showing another embodiment of the assembly 410. FIG. 4 shows the upper section 430, a lower section 440, and an artificial plant 435 of the disclosed assembly. The upper section can have a groove 450 at the bottom surface of the base of the upper section. The upper section can be placed on the lower section, wherein the groove fits around the rim of the lower section. The groove can be threaded and the outer surface of wall of the lower section adjacent the rim can have mating threads that allow the upper section to be threadedly fastened to the lower section. The upper section 430 can have a larger width than the lower section 440 providing a hanging appearance to the upper section. FIG. 5 shows another embodiment of the assembly 460.

A smaller size assembly can be placed on a table, shelf, countertop, and like platform as a decorative assembly that can be used to store small articles such as cotton balls, cotton swaps, or other small items found in the home or office. It could also be used to contain food items typically found on countertops such as ground coffee, tea bags, or other similar foods found in the kitchen or pantry. The large size assembly can be placed on a floor.

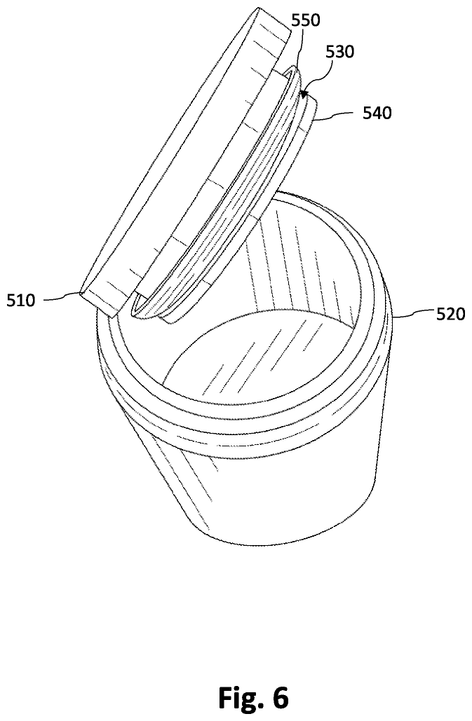

Referring to FIG. 6 which shows the upper section 510 and the lower section 520. The upper section 510 can have a circumferential groove 530 along the wall of the cylindrical sleeve 540. The groove 530 can retain a gasket 550, such as when the upper section is mounted over the lower section, the gasket can sandwich between the upper section and the lower section. Gasket can be made from a soft material, such as rubber or silicone. The gasket can be pressed against an inner wall of the lower section. Or the gasket can be pressed against the rim of the lower section.

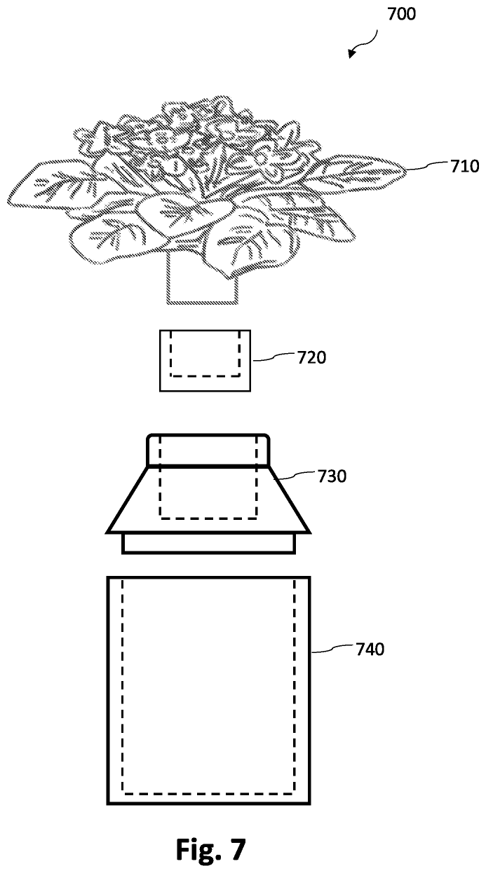

Referring to FIG. 7 which shows an exemplary embodiment of the assembly 700 having an artificial plant 710, a casing 720, an upper section 730, and a lower section 740. The casing 720 can hold the artificial plant 710 and the casing can be fit into the upper section 730. For example, the casing 720 can be heat shrink or crimped around bottom of the artificial plant 710. Alternatively, the artificial plant can also be adhered to the inside of the casing. The casing can then be mounted into the upper section. For example, the casing 720 can be snap fit into the upper section or the casing can be wedged into the upper section or the casing can also be threadedly coupled to the upper section or the casing may be press fit into the upper section. The casing can be mounted into the upper section using any of the method known to a skilled person without departing from the scope of the present invention. The artificial plant 710 with the casing 720 can be shipped separately and the assembly can be assembled by inserting the casing into the upper section. The casing can also be adhered using an adhesive to the upper section.

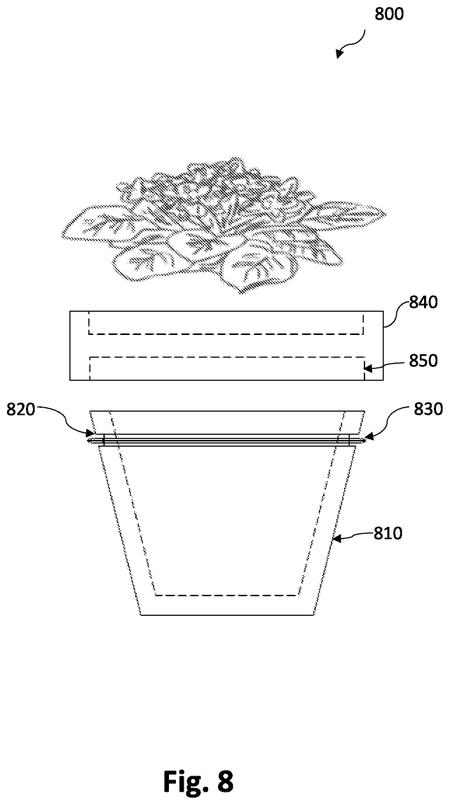

Referring to FIG. 8 showing an exemplary embodiment of the assembly 800 having the upper section 840 and the lower section 810. The lower section 810 can have a circumferential groove 820 near the top of the lower section. The groove 820 can retain a gasket 830, such as when the upper section 840 is mounted over the lower section 810, the gasket 830 can sandwich between the upper section 840 and the lower section 810. The upper section 840 can have a groove 850 at the bottom surface of the base of the upper section, such groove 850 can mount over the rim of the lower section 810 and periphery of the groove 850 can press against the gasket 830.

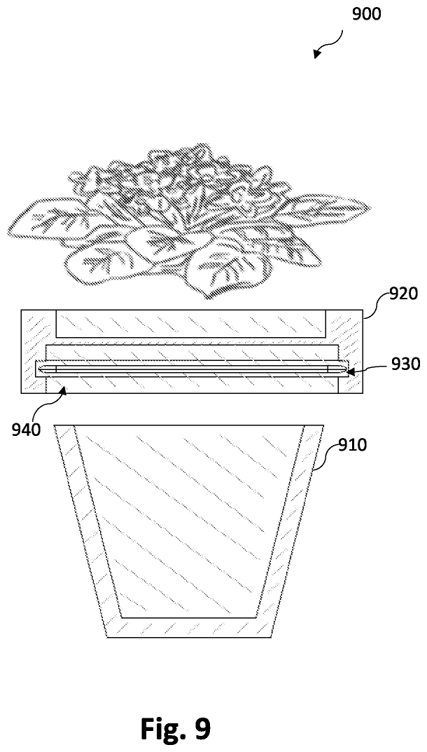

Referring to FIG. 9 shows an alternate embodiment of the assembly 900 having an upper section 920 and a lower section 910. The assembly shown in FIG. 9 can be a modification of the assembly shown in FIG. 4, wherein the groove 450 can be provided with a gasket. FIG. 9 shows a section view of the assembly 900 wherein the base of the upper section is having a groove 940 that can mount over the rim of the lower section 910. The groove 940 has a gasket 930 that can press against the rim of the lower section when the upper section 920 is placed over the lower section 910.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A multipurpose assembly resembling a potted plant, the multipurpose assembly comprising:
a lower section has a base and an upstanding wall defining an inner volume of the lower section, top of the lower section is open;
an upper section has an upstanding wall defining an inner volume of the upper section, the upper section removably mounted on the lower section closing the top of the lower section, the upper section configured to switch between an open state and a closed state, wherein the upper section can switch to the open state for gaining access to the inner volume of the lower section; and
an artificial plant that extends upwards from the inner volume of the upper section.

2. The multipurpose assembly according to claim 1, wherein the lower section is transparent.

3. The multipurpose assembly according to claim 1, wherein the multipurpose assembly further comprises an upstanding candle mounted to the base of the lower section.

4. The multipurpose assembly according to claim 1, wherein the upper section has a base, the base and the upstanding wall of the upper section define the inner volume of the upper section, a sleeve extends downwards from a center of a bottom surface of the base of the upper section, wherein a wall of the sleeve is continuous with the bottom surface of the base of the upper section forming a step, the step configured to juxtapose to a rim of the lower section for mounting the upper section to the lower section.

5. The multipurpose assembly according to claim 4, wherein the step has an outer layer of rubber or silicone material for forming a seal between the upper section and the lower section.

6. The multipurpose assembly according to claim 4, wherein the multipurpose assembly further comprises a gasket sandwiched between the upper section and the lower section.

7. The multipurpose assembly according to claim 1, wherein the inner volume of the upper section is having an inert filling.

8. The multipurpose assembly according to claim 1, wherein the upper section has a base, a bottom surface of the base of the upper section is having a groove, the groove dimensioned to mount over a rim of the lower section for mounting the upper section to the lower section.

9. The multipurpose assembly according to claim 8, wherein a gasket is provided in the groove of the upper section, wherein the gasket is pressed against the rim of the lower section when the upper section is mounted over the lower section.

10. The multipurpose assembly according to claim 8, wherein the lower section is having a circumferential groove near top along an outer surface of the upstanding wall of the lower section and a gasket fit into the circumferential groove.

11. The multipurpose assembly according to claim 1, wherein the lower section is a cylindrical container.

12. The multipurpose assembly according to claim 1, wherein the lower section is a cuboidal container.

13. The multipurpose assembly according to claim 1, wherein the lower section is a cubical container.

14. The multipurpose assembly according to claim 1, wherein the lower section is opaque.

15. The multipurpose assembly according to claim 1, wherein the multipurpose assembly further comprises a casing, the casing coupled to a bottom part of the artificial plant, the casing configured to mount into the upper section.

16. The multipurpose assembly according to claim 1, wherein the upper section has a base, the base and the upstanding wall of the upper section define the inner volume of the upper section, a skirt extends downwards from a periphery of the base of the upper section, the skirt configured to mount over a rim of the lower section for mounting the upper section to the lower section.

17. The multipurpose assembly according to claim 16, wherein the multipurpose assembly further comprises a gasket sandwiched between the upper section and the lower section.
